(19) United States
(12) Patent Application Publication
(10) Pub. No.: US 2004/0052904 A1
(43) Pub. Date: Mar. 18, 2004

(54) Strain of lactobacillus paracasei

(76) Inventors: Martin Antonsson, Svedala (SE); Anders Kjellgren, Kristianstad (SE); Goran Molin, Lund (SE); Frans Nilsson Bengt, Glimakra (SE); Gert Nilsson, Hoor (SE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/381,603

(22) PCT Filed: Oct. 3, 2001
(86) PCT No.: PCT/SE01/02140

(30) Foreign Application Priority Data
Oct. 4, 2000 (SE) 0003576-6

(51) Int. Cl. A23C 9/12

(52) U.S. Cl. 426/42

(57) ABSTRACT

The invention refers to the new strain Lactobacillus paracasei P1-3, DSM 13433, or a variant thereof, which can be used as an adjunct in the manufacture of cheese. The invention also refers to cheese containing said strain, especially low-fat cheese, having a reduced bitterness.

The present invention relates to a new strain of Lactobacillus paracasei which can be used as an adjunct in the manufacturing of cheese, especially low-fat cheese.

### BACKGROUND OF TH INVENTION

Swedish cheese is made from pasteurised cows milk which is fermented by a starter culture of lactic acid bacteria. The acidified milk is curdled by rennet (chymosin or other coagulating enzymes) and the coagulated milk is cut and stirred. The mixture of whey and cheese grains is gently heated. The whey is separated and the cheese grains pressed to a cheese which is salted and ripened; the order of whey separation and pressing depends on the cheese variety. During the ripening a secondary flora of mainly lactic acid bacteria is growing spontaneously. Swedish hard and semi-hard cheese will during the ripening be dominated by a spontaneously growing secondary microflora; often referred to as non-starter lactic acid bacteria, NSLAB. This spontaneous flora succeed the added starter culture and grow under the selective conditions of a maturing cheese. In order to control the process of ripening and the growth of the spontaneous flora of NSLAB, pure cultures of strains of for instance Lactabacillus have been used as adjuncts in cheese manufacturing. Said adjuncts in general might have an effect on the aroma and flavour of the cheese product; an effect which is not predictable but has to be tested by trial and error.

During the past decades the demand for low or reduced fat products on the market has increased in general, the traditional cheeses included. A full fat Swedish cheese contains at least 28% fat and the reduced fat varieties contain 17% and 10% fat, respectively. When a reduced fat cheese is produced the removed fat will be substituted by water and proteins if no special additives are used. The most common off-flavour in low-fat cheeses is bitterness, which mainly is derived from peptides having a basic amino acid in one end and a hydrophobic amino acid in the other end. This effect of the reduced fat content on the flavour is mainly due to the reduction of milk fat that dissolves flavour compounds in the cheese. In a normal fat cheese the bitter flavour from said peptides is hindered by their affinity to the fat-water interface in the cheese, the surface of which is larger than in a low-fat cheese. The perception of bitterness in a low-fat cheese might of course also depend on altered proteolytic activities in the cheese. By adding bacterial non-starter strains, that is adjuncts, or enzymes to the cheese the proteolysis of the milk protein during the cheese ripening can be altered. Lactobacillus paracasel strains are normally found growing spontaneous in Swedish cheese and can possess the desirerable proteolytic properties. From an economical point of view it is also cheaper to use a bacterial strain than a purified enzyme.

### DESCRIPTION OF THE DRAWINGS

FIG. 1 is the image of the REA-profile of the strain Lactobacillus paracasei P1-3, DSM 13433.

FIG. 2 is a photo of the RAPD-profile of the strain Lactobacillus paracasei P1-3, DSM 13433.

### DESCRIPTION OF THE INVENTION

The present invention relates to a new strain of Lactobacillus useful as an adjunct in the manufacturing of cheese, that is Lactobacillus paracasei P1-3, DSM 13433, or a variant thereof. It has surprisingly been found that this strain, when used as an adjunct, removes or reduces the bitter flavour often associated with cheese of a low fat content.

The new strain P1-3 has been deposited with the DSMZ-Deutsche Sammlung von Mikroorganismen und Zellkulturen Gmba, Macheroder Weg lb, 38124 Braunschweig, Germany, on Apr. 10, 2000, and has been given the accession number DSM 13433.

The new strain P1-3 was isolated from a Präst cheese with 55% fat in dry matter, after ripening for more than 12 months. 10 g was aseptically collected from the center of the cheese and homogenized with 90 ml of sterile 2% sodium citrate solution. After conventional dilution and plating on Rogosa agar separate columns were purified and characterized by Restriction Endonuclease Analysis, REA, and Randomly Amplified Polymorphic DNA, RAPD.

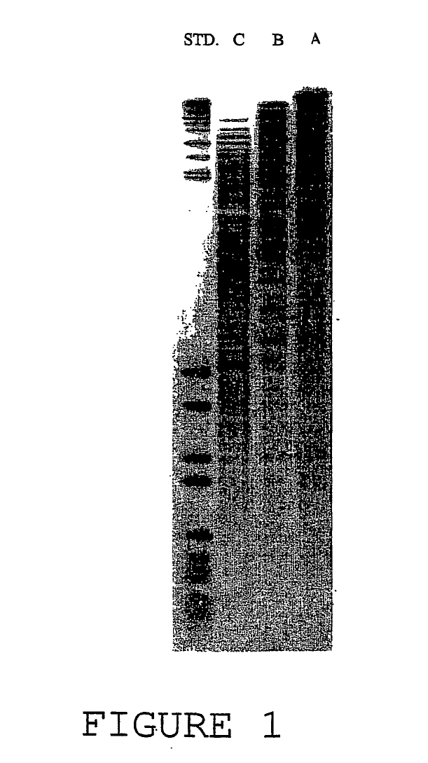

FIG. 1 shows the REA-profile of the strain, that is the Restriction Endonuclease Analysis profile obtained from the total chromosomal DNA after cutting with the restriction enzymes Hind III (lane C), Cla I (lane B) and Eco RI (lane A). STD stands for a size marker, which is a combination of High Molecular Marker (Life Technologies) and DNA Molecular Weight Marker VI (Rouche Molecular Biochemicals, Boehringer Mannheim). The REA-analysis was performed according to Johansson et al., International Journal of Systematic Bacteriology (1995) 10, 670675.

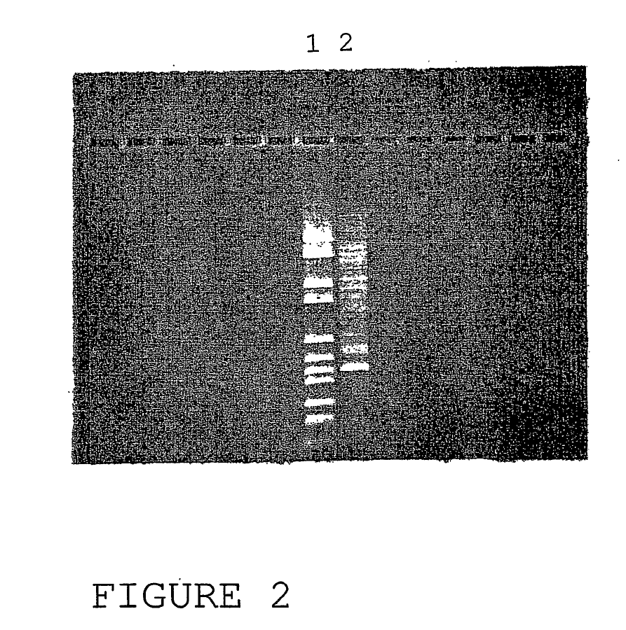

FIG. 2 shows the RAPD-profile of the strain (lane 2). Lane 1 is the DNA Molecular Weight Marker VI (Rouche Molecular Biochemicals, Boehringer Mannheim). The RAPD-analysis was performed as described by Quednau et al., 1998, Current Microbiology, 36, 332-336.

The strain of the invention can be stored in the form of a freeze dried preparation or frozen in a freezing buffer, such as Hogness freezing medium, in an amount of 10⁹-10¹¹ cfu/g.

The invention also refers to cheese containing a culture of Lactobacillus paracasei P1-3, DSM 13433, or a variant thereof, in an amount of 104-109 cfu/g, preferably 101-100 cfu/g.

According to a preferred aspect the new strain can be used in the manufacturing of rennet-coagulated, semi-hard or hard cheese from pasteurised cows milk having a fat content of 5-55% by weight of the dry matter, especially low-fat or medium fat cheese, that is cheese having a fat content of about 10-45% by weight, especially 15-35% by weight, of dry matter. It has in addition surprisingly been found that the strain of the invention will give the cheese a yellowish tone, which is appreciated by the consumer.

### EXAMPLIFICATION

In order to evaluate the survival and growth of a number of isolated adjunct strains, as well as the flavour development in cheese, cheeses were produced in a cheese model system as described by Antonsson, M., et al., Effect of Lactobacillus strains on the flavour of semi-hard cheese: An experimental cheese model for strain screening (to be submitted). As a result of said screening the strain of the invention was selected for testing in a larger scale in comparison with prior art adjunct cultures.

Tested Strains

Four different strains were selected for evaluation for use as adjunct culture in the production of a round-eyed cheese with 10% fat in dry matter. The selected cultures were in addition to the strain P1-3 according to the invention:

Flavor control CR-210, a commercially available culture (from CHR. Hansen, Denmark), containing Lactococcus lactis subsp. cremoris and Lactococcus lactis subsp. lactis, isolated from well known cheese cultures on the criteria that they had no or reduced capability to ferment lactose;

A culture consisting of Lactobacillus helveticus (LH192, from Danisco Cultor, Denmark); and

A culture consisting of Brevibacterium linens (from Danisco Cultor, Denmark).

### Example 1

### Manufacture of Low-Fat Cheese in Pilot-Plant Scale

Round-eyed cheese with 20% fat in dry matter was manufactured in a 400 l vat, according to a standard protocol, from pasteurised (73° C., 15 s) cows milk (Skånemejerier, Hörby, Sweden). The cheese milk was inoculated with ₁₀E cfu/ml of different adjunct cultures or combination of cultures into different batches. The cheeses were ripened at 12° C. in plastic foil for 10 weeks and then graded as to flavour by four graders on a scale 1-5 (1=very bad, 3=adequate, 5=very good), and analysed as to fat (FDM=fat in dry matter) and moisture (MNFS=moisture in non-fat solid) content. The results are given in Table 1 below.

TABLE 1

| Culture | Flavour | Comments | FDM % | MNFS % |
|---|---|---|---|---|
| CR 210, LH-192 | 3 | soft, acid, bitter | 23.3 | 62.2 |
| B. linens, LH-192 | 3 | rubbery, bitter | 23.5 | 58.6 |
| P1-3 | 4 | (soft), good flavour | 22.1 | 62.2 |

In the pilot plant scale the culture P1-3 gave the best flavour and especially interesting was that cheeses inoculated with this culture did not yield any bitter flavour.

If in the above trial the initial ripening took place at 16° C. for 14 days and then at 12° C. for the remaining 8 weeks an improvement of the taste was obtained.

### Example 2

### Manufacture of Low-Fat Cheese in Full-Scale

Round-eyed cheeses with 20% fat in dry matter were manufactured in full scale and with similar combinations of cultures as in the pilot-plant trial. The cheeses were ripened and graded as in Example 1 and the results are given in Table 2 below.

TABLE 2

| Culture | Flavour | Comments | FDM % | MNFS % |
|---|---|---|---|---|
| CR 210 | 4 | soft, salt, bitter | 22.1 | 59.4 |
| CR 210, LH-192 | 3 | rubbery, salt, | 22.2 | 59.8 |
| | | bitter, flavourless | | |
| P1-3 | 4 | dry, salt | 22.5 | 58.7 |

In this full scale trial the same effect was seen, that is the culture P1-3 yielded cheese of the best quality and the previous pattern with no bitterness in cheese containing this culture was repeated. The cheeses manufactured with culture CR 210 had similar flavour scores as cheeses manufactured with the strain P1-3, but the texture of cheese made with P1-3 was deemed to be of a superior quality in the pre-grading compared to the other cheeses.

### Example 3

### Manufacture of 30+ Cheese

In order to improve the flavour of reduced fat Präst cheese, that is a semi-hard Swedish cheese having a fat content of 17%, the strain Lactabacillus paracasei P1-3 was added as an adjunct during the manufacture, which took place in accordance with a conventional protocol, and the cheeses obtained, as well as control cheeses without adjunct, were ripened for 40 weeks. After a ripening time of 16 weeks the number of lactobacilli is larger in the control cheeses, but after 40 weeks the number of lactobacilli is larger in the inoculated cheeses. This means that the added culture is able to control the spontaneous growing lactobacilli during ripening. It was also found that the taste of the inoculated cheese was improved from about 25 weeks of ripening, as compared with the control.

Conclusion

The strain P1-3 has been shown to have the ability to remove bitter flavour from the low-fat cheese which has been manufactured in different trials and scales. This is probably due to a proteolytic activity towards bitter tasting peptides. The precise mechanism is, however, not yet elucidated. In addition the new strain P1-3 has a beneficial effect on the eye formation. This later effect is believed to be achieved by a beneficial co-existence in the cheese of the new strain with the mesophilic starter culture, which is responsible for the eye formation. Finally an improvement of the taste and colour of a reduced fat cheese is obtained after approximately 25 weeks of ripening.

1. Lactobacillus paracasei P1-3, DSM 13433, or a variant thereof.

2. Lactobacillus paracasei P1-3, DSM 13433, or a variant thereof, according to claim 1, in a freezing buffer in an amount of 10⁹-10¹⁵ cfu/g.

3. Lactobacillus paracasei P1-3, DSM 13433, or a variant thereof, according to claim 1 or 2, for use as an adjunct in the manufacture of cheese.

4. Cheese containing a culture of Lactobacillus paracasei P1-3, DSM 13433, or a variant thereof.

5. Semi-hard or hard cheese according to claim 4, having a fat content of 5-55% by weight of dry matter, characterized in containing the strain Lactobacillus paracasei P1-3, DSM 13433, or a variant thereof in an amount of 10⁴-10⁹ cfu/g.

6. Low-fat or medium fat cheese according to claim 4 or 5, having a fat content of 10-45% by weight of dry matter, characterized in containing the strain Lactobacillus paracasei P1-3, DSM 13433, or a variant thereof in an amount of 10⁴-10⁹ cfu/g.
